(19) United States
(12) Patent Application Publication
(10) Pub. No.: US 2020/0355951 A1
(43) Pub. Date: Nov. 12, 2020

(54) LIQUID CRYSTAL DISPLAY DEVICE AND DISPLAY CONTROL METHOD THEREOF

(71) Applicant: HUIZHOU CHINA STAR OPTOELECTRONICS TECHNOLOGY CO., LTD., Huizhou Guangdong (CN)

(72) Inventors: Chunchi CHEN, Huizhou Guangdong (CN); Yuchun HSIAO, Huizhou Guangdong (CN); Shujhih CHEN, Huizhou Guangdong (CN)

(21) Appl. No.: 16/082,493

(22) PCT Filed: Apr. 24, 2018
(86) PCT No.: PCT/CN2018/084181

§ 371 Date: Sep. 5, 2018

(30) Foreign Application Priority Data
Mar. 23, 2018 (CN) 201810245898.7

(51) Int. Cl. G02F 1/1347; G02F 1/1335; G02F 1/133

(52) U.S. Cl. CPC G02F 1/1347; G02F 1/133528; G02F 2001/133742; G02F 1/133504; G02F 1/13306

(57) ABSTRACT

The invention discloses an LCD device comprising a backlight unit and an LC panel disposed oppositely, wherein LC panel comprising a first polarizer, a first LC cell, and a second polarizer sequentially disposed on backlight unit, the LCD device further comprising a brightness enhancement film, a second LC cell, and a third polarizer sequentially disposed on second polarizer; light absorption axes of the first polarizer and second polarizer being mutually perpendicular; absorption axes of the third polarizer and the second polarizer being mutually parallel, and the second LC cell being a VA mode LC cell. The invention also discloses a display control method of LCD device, so that the liquid crystal display device realizes a mirror display mode and an image display mode. The invention can avoid the interference problem between the mirror display and the image display in the LCD, thereby improving the display quality.

### BACKGROUND OF THE INVENTION

### 1. Field of the Invention

The present invention relates to the field of display, and in particular to the field of a liquid crystal display (LCD) device and display control method thereof.

### 2. The Related Arts

A liquid crystal display (LCD) device is a flat and ultra-thin display device, which cis composed of a certain number of color or black and white pixels and placed in front of a light source or a reflective surface. The power consumption of the LCD device is very low, and the LCD has characteristics such as high image quality, small size, and light weight, and therefore is favored by users and becomes the mainstream of the display.

Most of the known LCD devices are transmissive LCD devices, which comprise an LCD panel and a backlight unit. The operation principle of the LCD panel is to place liquid crystal (LC) molecules between two parallel glass substrates, electrodes are respectively arranged on the two glass substrates, and the LC molecules are controlled to change directions by whether the electricity is supplied to the electrodes or not, and the light from the backlight unit passes through the LCD panel. To produce an image. The aforementioned transmissive LCD devices generally provides only a simple display function. However, with the continuous progress of display technology, various new types of display devices have been invented, and various manufacturers have more actively developed multi-function display devices. Multi-functional display devices have also become one of the goals pursued by consumers. Typical multi-functional display devices are touch display devices and mirror display devices.

A mirror display device is a new type of display device able to display images as well as reflecting images for use as a mirror. In a mirror display device, in general, to achieve a mirror effect, a reflection layer is generally provided on the display panel. The reflection layer can reflect both ambient light and part of the light emitted from the display panel, to achieve both effects of a mirror and a display. In the prior art, a brightness enhancement film is usually added on the display panel to achieve crystal surface display.

FIG. 1 is a schematic view showing the structure of a conventional mirror display device. As shown in FIG. 1, the mirror display device comprises a backlight unit 1 and an LC panel 2, and the LC panel 2 comprises a lower polarizer 2a and an LC cell 2b and an upper polarizer 2c sequentially disposed on the backlight unit 1. The mirror display device further comprises a brightness enhancement film 3 disposed on the upper polarizer 2c. When the mirror display displays, the LC panel 2 is controlled so that the light emitted from the backlight unit 1 cannot pass through the LC panel 2. At this point, the external ambient light is reflected to the human eye by the brightness enhancement film 3, thereby achieving the mirror effect. During image display, the LC panel 2 is controlled so that the light emitted from the backlight unit 1 can penetrate the LC panel 2 to display a corresponding image, but at this point, the brightness enhancement film 3 also reflects external ambient light and reflects ambient light, which causes interference with the displayed image and reduce the display quality of the image screen.

Therefore, the prior art requires improvement and further development.

### SUMMARY OF THE INVENTION

To overcome the aforementioned problems in the prior art, the present invention provides an LCD device and a display control method thereof, able to avoid the problems of interference between the mirror display and the image display in the LCD device and improve the display quality.

To achieve the above object, the present invention provides the following technical solution:

a liquid crystal display (LCD) device, which comprises: a backlight unit and a liquid crystal (LC) panel, disposed opposite to each other, wherein the LC panel comprising a first polarizer, a first LC cell, and a second polarizer sequentially disposed on the backlight unit, wherein the LCD device further comprising a brightness enhancement film, a second LC cell, and a third polarizer sequentially disposed on the second polarizer; wherein light absorption axis of the first polarizer and light absorption axis of the second polarizer being perpendicular to each other absorption axis of the third polarizer and the absorption axis of the second polarizer being parallel to each other, and the second LC cell being a vertical alignment (VA) mode LC cell.

According to an embodiment of the present invention, the first LC cell comprises a thin film transistor (TFT) array substrate and a color filter (CF) substrate, disposed opposite to each other, and a first LC layer is disposed between the TFT array substrate and the CF substrate.

According to an embodiment of the present invention, the first LC cell is a VA mode LC cell.

According to an embodiment of the present invention, the first LC cell is a single-domain, double-domain or a multi-domain VA mode LC cell.

According to an embodiment of the present invention, the first LC cell is a twisted nematic (TN) mode or an in-plane switching (IPS) VA mode LC cell.

According to an embodiment of the present invention, the second LC cell comprises a first electrode plate and a second electrode plate, disposed opposite to each other, and a second LC layer is disposed between the first electrode plate and the second electrode plate.

According to an embodiment of the present invention, the second LC cell is a single-domain VA mode LC cell.

The present invention also provides a display control method of the aforementioned LCD device, the LCD device having a mirror display mode and an image display mode, wherein the display control method comprises:

in the mirror display mode, controlling the first LC cell so that a deflecting in polarization direction not occurring when a polarized light passing through the LC layer, and controlling the second LC cell so that a deflection in polarization direction occurring when a polarized light passing through the LC layer;

in the image display mode, controlling the first LC cell so that a deflecting in polarization direction occurring when a polarized light passing through the LC layer, and controlling the second LC cell so that a deflection in polarization direction not occurring when a polarized light passing through the LC layer.

In the LCD device and the display control method provided by the embodiments of the present invention, a brightness enhancement film, a second LC cell, and a third polarizer are sequentially disposed on an LC panel, and the LC panel controls the LC state of one of the LC panel and the second LC cell to reflect external ambient light and transmit the transmitted backlight through the display surface, thereby avoiding the problem of interference between the mirror display mode and the image display mode in the LCD device and improving the display quality.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort.

FIG. 1 is a schematic view showing the structure of ta known mirror display device.

FIG. 2 is a schematic view showing the structure of LCD display device according to the embodiment of the present invention.

FIG. 3 is a schematic view showing the LCD device in FIG. 2 when performing mirror displaying.

FIG. 4 is a schematic view showing the LCD device in FIG. 2 when performing image displaying.

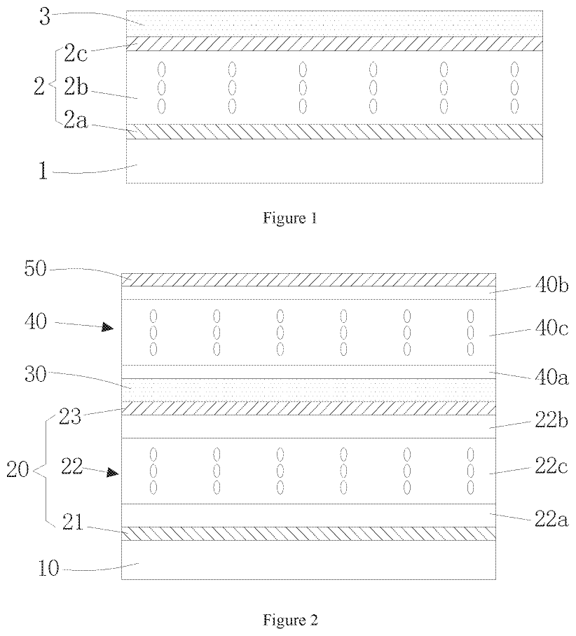

### DETAILED DESCRIPTION OF THE PREFERRED EMBODIMENTS

To further explain the technical means and effect of the present invention, the following refers to embodiments and drawings for detailed description. Apparently, the described embodiments are merely some embodiments of the present invention, instead of all embodiments. All other embodiments based on embodiments in the present invention and obtained by those skilled in the art without departing from the creative work of the present invention are within the scope of the present invention.

The terms “comprising” and “having” and any variations thereof appearing in the specification, claims, and drawings of the present application are intended to cover non-exclusive inclusion. For example, a process, method, system, product, or device that includes a series of steps or units is not limited to the listed steps or units, but optionally also includes steps or units not listed, or alternatively, other steps or units inherent to these processes, methods, products or equipment. In addition, the terms “first”, “second” and “third” are used to distinguish different objects, and are not intended to describe a particular order.

The present invention provides a liquid crystal display (LCD) device, the LCD device provides a mirror display mode and an image display mode. As shown in FIG. 2, the LCD comprises: a backlight unit 10 and a liquid crystal (LC) panel 20, disposed opposite to each other. The LC panel 20 comprises a first polarizer 21, a first LC cell 22, and a second polarizer 23 sequentially disposed on the backlight unit 10. Moreover, the LCD device further comprises a brightness enhancement film 30, a second LC cell 40, and a third polarizer 50 sequentially disposed on the second polarizer 23.

Wherein light absorption axis of the first polarizer 21 and light absorption axis of the second polarizer 23 are perpendicular to each other; absorption axis of the third polarizer 50 and the absorption axis of the second polarizer 23 are parallel to each other, and the second LC cell 40 is a vertical alignment (VA) mode LC cell. Specifically, for example, the direction of the absorption axis of the first polarizer 21 is 0°, and the direction of the absorption axis of the second polarizer 23 and the third polarizer 50 is 90°.

Wherein the backlight unit 10 can be either edge-lit backlight unit or direct-lit backlight unit.

As shown in FIG. 2, the first LC cell 22 comprises a thin film transistor (TFT) array substrate 22a and a color filter (CF) substrate 22b, disposed opposite to each other, and a first LC layer 22c is disposed between the TFT array substrate 22a and the CF substrate 22b. In general, the TFT array substrate 22a comprises TFTs and pixel electrodes arranged on a glass substrate in an array, and data lines and scan lines crossing-over each other. The CF substrate 22b mainly comprises a CF layer and a common electrode layer formed on a glass substrate, and the CF layer mainly comprises a red photoresist, a green photoresist, and a blue photoresist and a black matrix (BM) separating the color photoresists from one another.

In the present embodiment, the first LC cell 22 is a VA mode LC cell. Specifically, the first LC cell 22 can be a single-domain, double-domain or a multi-domain VA mode LC cell. In other embodiments, the first LC cell 22 can be of other modes, such as, a twisted nematic (TN) mode or an in-plane switching (IPS) VA mode LC cell. In other words, the first LC cell 22 can be selected from any of the known LC cells.

Wherein, the brightness enhancement film 30 is used for reflecting external ambient light penetrating from the third polarizer 50 and the second LC cell 40, when the reflected external ambient light can be emitted from the third polarizer 50, a mirror display is formed.

Wherein, the second LC cell 40 can be regarded as a light valve. Specifically, as shown in FIG. 2, the second LC cell 40 comprises a first electrode plate 40a and a second electrode plate 40b disposed opposite to each other, and a second LC layer 44c is disposed between the first electrode plate 44a and the second electrode plate 44b. A electric field is formed by controlling the voltages applied to the first electrode plate 44a and the second electrode plate 44b to adjust the deflection of the LC of the second LC layer 44c so as to control whether light can penetrate the second LC cell 40. In the present embodiment, the second LC cell 40 is a single-domain VA mode LC cell.

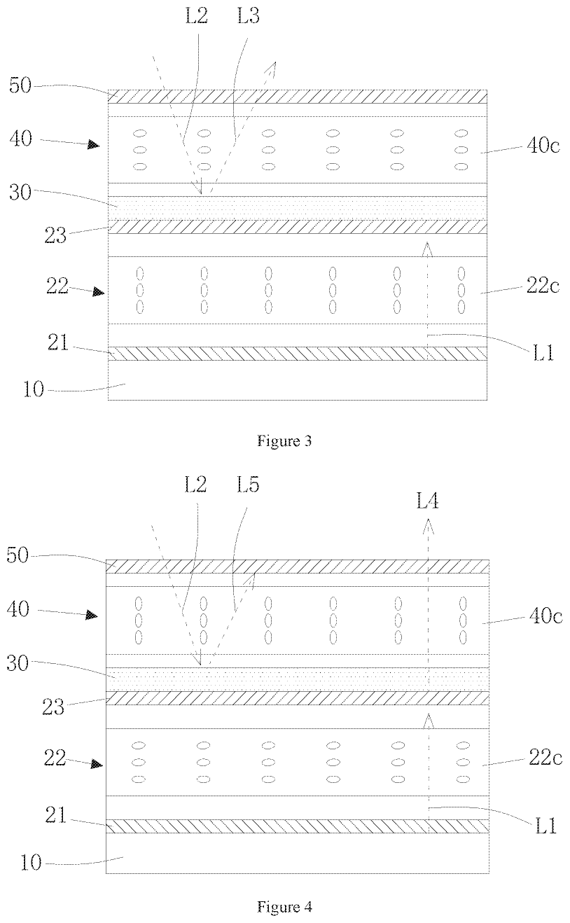

The display control method of the LCD device of the above embodiment is described with reference to FIG. 3 and FIG. 4. As described above, the LCD device provided by the present embodiment provides a mirror display mode and an image display mode. Specifically, the display control method comprises:

(1) as shown in FIG. 3, in the mirror display mode, controlling the first LC cell 22 so that a deflecting in polarization direction not occurring when a polarized light passing through the LC layer 22c, and controlling the second LC cell 40 so that a deflection in polarization direction occurring when a polarized light passing through the LC layer 40c.

Specifically, as shown in FIG. 3, in the mirror display mode, the light emitted from the backlight unit 10 passes through the first polarizer 21 to form a polarized light L1, and the first LC cell 22 is controlled so that the polarization direction is not deflected when the polarized light passes through the liquid crystal layer 22c. Since the absorption axis of the second polarizer 23 and the absorption axis of the first polarizer 21 are perpendicular to each other, the polarized light L1 cannot be emitted from the second polarizer 23. The external ambient light passes through the third polarizer 50 to form a polarized light L2. When the second LC cell 40 is controlled so that the polarization direction of the polarized light is deflected when passing through the LC layer 40c therein. Because the polarized light is also deflected when reflected by the brightness enhancement film 30, which, in conjunction with deflection of the polarized light by the LC layer 40c, a polarized light L3 formed after reflection can be emitted from the third polarizer 50 to form a mirror display. Based on the above display process, since the light emitted from the backlight unit 10 cannot penetrate the first LC cell 22, that is, cannot reach the display surface, the mirror display will not be interfered by the backlight.

(2) as shown in FIG. 4, in the image display mode, controlling the first LC cell 22 so that a deflecting in polarization direction occurring when a polarized light passing through the LC layer, and controlling the second LC cell 40 so that a deflection in polarization direction not occurring when a polarized light passing through the LC layer.

Specifically, as shown in FIG. 4, in the image display mode, the light emitted from the backlight unit 10 passes through the first polarizer 21 to form a polarized light L1, and the first LC cell 22 is controlled so that the polarization direction is deflected when the polarized light passes through the liquid crystal layer 22c. Since the absorption axis of the second polarizer 23 and the absorption axis of the first polarizer 21 are perpendicular to each other, the polarized light L1 can be emitted from the second polarizer 23. Moreover, since the polarization direction is not deflected when the second LC cell 40 is controlled so that the polarized light passes through the LC layer 40c therein is not deflected, and the absorption axis of the third polarizer 50 and the absorption axis of the second polarizer 23 are parallel to each other, the polarization light L4 can be emitted by the third polarizer 50 to perform corresponding image display.

The external ambient light passes through the third polarizer 50 to form the polarized light L2. Since the second LC cell 40 is controlled so that the polarization direction is not deflected when the polarized light passes through the LC layer 40c therein, the polarized light L2 is reflected by the brightness enhancement film 30 to form a polarized light L5, wherein a deflection occurs. The polarized light L5 cannot be emitted from the third polarizer 50 and does not reach the display surface. Therefore, the image display is not interfered by the reflected light.

In summary, in the LCD device and the display control method provided by the embodiments of the present invention, the LC panel controls the LC state of one of the LC panel and the second LC cell to reflect external ambient light and transmit the transmitted backlight through the display surface, thereby avoiding the problem of interference between the mirror display mode and the image display mode in the LCD device and improving the display quality.

It should be noted that each of the embodiments in this specification is described in a progressive manner, each of which is primarily described in connection with other embodiments with emphasis on the difference parts, and the same or similar parts may be seen from each other. For the device embodiment, since it is substantially similar to the method embodiment, the description is relatively simple and the relevant description may be described in part of the method embodiment.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the claims of the present invention.

What is claimed is:

1. A liquid crystal display (LCD) device, which comprises: a backlight unit and a liquid crystal (LC) panel, disposed opposite to each other, wherein the LC panel comprising a first polarizer, a first LC cell, and a second polarizer sequentially disposed on the backlight unit, wherein the LCD device further comprising a brightness enhancement film, a second LC cell, and a third polarizer sequentially disposed on the second polarizer; wherein light absorption axis of the first polarizer and light absorption axis of the second polarizer being perpendicular to each other absorption axis of the third polarizer and the absorption axis of the second polarizer being parallel to each other, and the second LC cell being a vertical alignment (VA) mode LC cell.

2. The LCD device as claimed in claim 1, wherein the first LC cell comprises a thin film transistor (TFT) array substrate and a color filter (CF) substrate, disposed opposite to each other, and a first LC layer is disposed between the TFT array substrate and the CF substrate.

3. The LCD device as claimed in claim 2, wherein the first LC cell is a VA mode LC cell.

4. The LCD device as claimed in claim 3, wherein the first LC cell is a single-domain, double-domain or a multi-domain VA mode LC cell.

5. The LCD device as claimed in claim 2, wherein the first LC cell is a twisted nematic (TN) mode or an in-plane switching (IPS) VA mode LC cell.

6. The LCD device as claimed in claim 2, wherein the second LC cell comprises a first electrode plate and a second electrode plate, disposed opposite to each other, and a second LC layer is disposed between the first electrode plate and the second electrode plate.

7. The LCD device as claimed in claim 6, wherein the second LC cell is a single-domain VA mode LC cell.

8. A display control method of liquid crystal display (LCD) device, the LCD device comprising a backlight unit and a liquid crystal (LC) panel, disposed opposite to each other, wherein the LC panel comprising a first polarizer, a first LC cell, and a second polarizer sequentially disposed on the backlight unit, wherein the LCD device further comprising a brightness enhancement film, a second LC cell, and a third polarizer sequentially disposed on the second polarizer; wherein light absorption axis of the first polarizer and light absorption axis of the second polarizer being perpendicular to each other; absorption axis of the third polarizer and the absorption axis of the second polarizer being parallel to each other, and the second LC cell being a vertical alignment (VA) mode LC cell, and the LCD device providing a mirror display mode and an image display mode; wherein the display control method comprising:
in the mirror display mode, controlling the first LC cell so that a deflecting in polarization direction not occurring when a polarized light passing through the LC layer, and controlling the second LC cell so that a deflection in polarization direction occurring when a polarized light passing through the LC layer;
in the image display mode, controlling the first LC cell so that a deflecting in polarization direction occurring when a polarized light passing through the LC layer, and controlling the second LC cell so that a deflection in polarization direction not occurring when a polarized light passing through the LC layer.

9. The display control method of LCD device as claimed in claim 8, wherein the first LC cell comprises a thin film transistor (TFT) array substrate and a color filter (CF) substrate, disposed opposite to each other, and a first LC layer is disposed between the TFT array substrate and the CF substrate.

10. The display control method of LCD device as claimed in claim 9, wherein the first LC cell is a VA mode LC cell.

11. The display control method of LCD device as claimed in claim 10, wherein the first LC cell is a single-domain, double-domain or a multi-domain VA mode LC cell.

12. The display control method of LCD device as claimed in claim 9, wherein the first LC cell is a twisted nematic (TN) mode or an in-plane switching (IPS) VA mode LC cell.

13. The display control method of LCD device as claimed in claim 9, wherein the second LC cell comprises a first electrode plate and a second electrode plate, disposed opposite to each other, and a second LC layer is disposed between the first electrode plate and the second electrode plate.

14. The display control method of LCD device as claimed in claim 13, wherein the second LC cell is a single-domain VA mode LC cell.
